(19) United States
(12) Patent Application Publication
(10) Pub. No.: US 2026/0028485 A1
(43) Pub. Date: Jan. 29, 2026

(54) MULTICOMPONENT CORROSION INHIBITOR MIX FOR FILM-FORMING BINDERS TO PROTECT METAL SUBSTRATES

(71) Applicant: The Patent Well LLC, Fort Worth, TX (US)

(72) Inventor: Ryan Merritt, Grapevine, TX (US)

(21) Appl. No.: 19/281,202

(22) Filed: Jul. 25, 2025

Related U.S. Application Data
(60) Provisional application No. 63/676,749, filed on Jul. 29, 2024.

(51) Int. Cl. C09D 5/08; C08K 3/32; C08K 5/00; C09D 7/20; C09D 7/61; C09D 163/00

(52) U.S. Cl. CPC C09D 5/084; C08K 3/32; C08K 5/0091; C09D 7/20; C09D 7/61; C09D 163/00; C08K 2003/326; C08K 2003/328; C08K 2201/014

(57) ABSTRACT

Corrosion inhibitor mixes comprising multiple salts. One mix includes zinc citrate, zinc oxalate and magnesium phosphate. A second mix includes the same two zinc salts, nickel oxalate and nickel phosphate. Either mix may be added to a film-forming binder such as a polymer suitable for a paint or primer, to inhibit corrosion, especially when used with a metallic substrate. The resulting product of the inhibitor mix and binder is especially useful in inhibiting corrosion when applied to an aircraft surface.

### CROSS-REFERENCE TO RELATED APPLICATION

This application claims the benefit of U.S. Provisional Patent Application No. 63/676,749 filed Jul. 29, 2024, which is hereby incorporated.

### BACKGROUND OF THE INVENTION

### Field of the Invention

The present invention generally relates to corrosion inhibitors for use with film-forming binders to protect metallic surfaces.

### Description of the Related Art

Many metals are susceptible to corrosion, especially when exposed to hostile environments such as found around vehicles, including airborne, seaborne and land based vehicles. This corrosion may include galvanic corrosion at the surface of the metals especially in the presence of an electrolyte, such as salt water. To combat corrosion, paint, primers or other film-forming binders may be used to coat metallic surfaces and help prevent its exposure to the weather. These binders may contain corrosion inhibiting compositions that in some embodiments may react with the surface of the metal to inhibit corrosion including galvanic corrosion. However, these chemicals must be designed so as to inhibit and not promote corrosion, which sometimes is a difficult task and may require extensive experimentation to determine effectiveness on certain metal substrates.

It is known to put corrosion inhibitor mixes in film-forming binders, see U.S. Pat. Nos. 10,351,715 and 10,889,723 both of which are hereby incorporated by reference.

### SUMMARY OF THE INVENTION

The present invention in at least one embodiment is generally directed to a novel multi-component corrosion inhibitor sometimes for use with a film-forming binder. The multi-component corrosion inhibitor comprises at least three metallic salt components.

At least one of the at least three metallic salt components may be lithium free. The lithium free metallic salt may be a phosphate salt. The phosphate salt may be nickel phosphate or magnesium phosphate.

One of the at least three metallic salt components may be a non-phosphate lithium salt.

The multi-component corrosion inhibitor may comprise four metallic salt components, for example: two metal polycarboxylate salts preferably a zinc citrate and a zinc oxalate, a nickel salt preferably nickel oxalate, and a nickel phosphate. In this embodiment a non-phosphate lithium salt may be substituted for the nickel phosphate.

In an alternative embodiment the at least three metallic salt components include zinc citrate, zinc oxalate and magnesium phosphate. In this embodiment a non-phosphate lithium salt may be substituted for the magnesium phosphate.

Example: Take 2 mole of Zinc Oxalate and 1 mole Zinc Citrate, 1 mole Nickel Oxalate, 1 mole Nickel Phosphate. In the four part mix a non-phosphate lithium salt may be substituted for the nickel phosphate.

The above as well as additional objectives, features, and advantages in the various embodiments of the present invention will become apparent in the following detailed written description.

### DESCRIPTION OF THE PREFERRED EMBODIMENT(S)

In a broad embodiment, the multi-component corrosion inhibitor composition of the present invention comprises at least two metal polycarboxylate salts and at least one non-lithium metallic salt. In some embodiments the at least two metal polycarboxylate salts are chosen from the anion group consisting of citrates and oxalates. In some embodiments both of the carboxylate salts are zinc carboxylates, one a citrate and one an oxalate. In some embodiments the third metal salt is a nickel oxalate, nickel phosphate or magnesium phosphate, and preferably is magnesium phosphate. An additional fourth metal salt may be present if the third metal salt is a nickel oxalate. The fourth metal salt may be selected from the group containing a non-lithium metallic phosphate, in some embodiments a nickel or magnesium phosphate, preferably nickel phosphate.

Example A, a three part inhibitor comprising, and in some embodiments consisting of or in other embodiments consisting essentially of:
Zinc citrate. Zinc citrate (C₁₂H₁₀O₁₄Zn₃) is a zinc salt of a citric acid, is slightly soluble in water, and is used in dental and pharmaceutical products.
Zinc oxalate. Zinc Oxalate (ZnC₂O₄) is a white crystalline powder at room temperature and may be used to treat metals.
Magnesium phosphate. Magnesium phosphate (Mg₃(PO₄)₂) is used as a muscle relaxant.
   Example B is a four part inhibitor comprising, or in some embodiments consisting of or in other embodiments consisting essentially of:
The zinc citrate and zinc oxalates set forth above.
Nickel Oxalate (C₂NiO₂). Nickel Oxalate is a light green powder that is insoluble in water and may be used in the manufacture of metals.
Nickel phosphate (Ni₃(PO₄)₂) is a paramagnetic, light green solid, insoluble in water and is used in electroplating metals.

All of the above ingredients may be purchased from chemical supply houses or manufactured in the lab through known reactions. All are powders at room temperature and safe to handle.

In some embodiments any of the multi-component corrosion inhibitor combinations set forth herein may be mixed into a film-forming binder for use on a metallic substrate including an aluminum alloy substrate. In some embodiments the multi-component corrosion inhibitor combination may be mixed into a curable binder prior to curing, and in some embodiments the curable binder is a polymer, including an amine epoxy. The corrosion inhibitor combination may be mixed into the binder at a weight ratio of 10% to 90% (10%- 65%).

In some embodiments the curable binder is a one part, in some embodiments the binder is a two part, a resin side and a curing agent side (hardener), the inhibitor combination may be mixed in one or both sides.

Metal particles, in some embodiments metal particles between 1 and 200 microns (in some embodiments 1-70 microns) longest dimension may be added to the coating to provide further protection for a metal substrate, when the metal particles are more anodic than the metal substrate to which the coating composition is applied. In this manner, the metal particles may act as sacrificial anodes. The metal particles may be coated aluminum alloy particles. For metal particles, coated and uncoated, as well as film-forming binders see the following, all incorporated herein by reference: U.S. Pat. Nos. 8,262,938; 8,277,688; 9,243,333; 9,243,150; U.S. Patent Application Publication no. 2012/0025142; and Patent Cooperation Treaty Application no. US2018/066843. In some embodiments the metal particles are high silicon aluminum, with 20% silicon, 0.05% tin and 0.02% indium (percentages by weight). In some embodiments the coated or uncoated particles may be an alloy of aluminum containing zinc and indium.

The metal particles may be coated with a semi-conducting corrosion inhibiting coating.

The semi-conducting corrosion-inhibiting coating may be provided by a nanometer scale semi-conducting corrosion inhibiting oxide, the oxide derived from an acidic aqueous solution consisting essentially of, in parts by weight, from
0.01 to 22 parts of a trivalent chromium compound, from
0.01 to 12 parts of a hexafluorozirconate, from
0.01 to 12 parts of at least one fluorocompound selected from the group consisting of tetrafluoroborates, hexafluorosilicates, and hexafluorotitanates.

In one embodiment the coating composition is curable below 120° C. and comprises a film-forming resin, a curing agent for the film-forming resin, and a four part corrosion inhibitor mix comprising zinc citrate, a zinc oxalate, a nickel oxalate and a nickel phosphate salt. In another embodiment the inhibitor mix comprises three parts, the two zinc components and magnesium phosphate.

The film-forming binder may be a resin and may be selected from the group consisting of epoxy resins, polyesters, polyacrylates, polyurethanes, polyethers, polyaspartic esters, polysiloxanes, isocyanates, mercapto-functional resins, amine-functional resins, amide-functional resins, imide-functional resin, silane-containing resins, polysiloxanes, acetoacetate resins, functional fluorinated resins, alkyd resins, and mixtures thereof.

The following corrosion inhibiting coatings were prepared in the following combinations. One coating of each (3 and 4 part mixes) were prepared combining the mixes into an amine epoxy binder at loading of 20-80% by volume prior to curing (brushed on) to a thickness of about 1-3 mil on a clean aluminum 2024 alloy 3″×6″ substrate, allowed to dry.

### Step 1: Solvate Resin.

Resin Epon 1001 F
40% MAK (methyl amyl ketone): 60% Epon 1001F (% by weight)

### Step 2: Make Binder.

83.3 grams MAK: Epon mix with 4.21 grams of Ethacure 2000 (amine curative) for binder.

### Step 3: Mix Inhibitors

Example C: Take 2 mole of Zinc Oxalate or 60% by weight of inhibitor mix (25-75%), 1 mole of Zinc Citrate or 25% (25-75%), and 1 mole of magnesium phosphate 15% (5-30%). In the three part mix a non-phosphate lithium salt may be substituted for the magnesium phosphate. or,
Example D: Take 2 mole of Zinc Oxalate and 1 mol Zinc Citrate: (same weight percentages as set forth above), 1 mole Nickel Oxalate 7.5% (5-30%): 1 mole Nickel Phosphate 7.5% (5-30%). In the four part mix a non-phosphate lithium salt may be substituted for the nickel phosphate.
Tumble and mix until it forms a homogeneous powder.

### Step 4: Make Coating

Take 10 g of TCP (trichromium)-passivated aluminum alloy (AlZnIn) particles 1-70 microns longest dimension, add 4 grams of inhibitors mix, add 12 grams of binder mix, and finish in a shear mixer under vacuum for 2 mins at 1500 rpm or until thoroughly mixed.

Initial Open Cell Potential (OCP) and Potentiodyanmic Polarization tests were run (Gamry Instruments potentiostat Model # Reference 620) and the inhibitor combinations were shown to be successful in preventing corrosion against a non-inhibitor control and compared favorably against several inhibitor combinations some that included lithium salt.

Standard salt fog testing confirmed the effectiveness of the examples of the inhibitor mixes set forth herein on aluminum alloy substrates.

The corrosion inhibitor composition may be mixed with a binder to form a paint, a primer, a grease, an oils, a gel, a wax, an elastomer, a sealant, a gasket or a gasket material.

The binder compositions disclosed herein are especially useful in paints and primers for application to aircraft surfaces, including exterior and interior surfaces, including those comprising aluminum alloy.

The above-described embodiments are intended to be examples only. Alterations, modifications and variations can be affected to the particular embodiments by those of skill in the art. The scope of the claims should not be limited by the particular embodiments set forth in the examples but should be given the broadest interpretation consistent with the specification as a whole.

What is claimed is:

1. A corrosion inhibitor composition comprising at least two metal polycarboxylate salts and at least one non-lithium metallic phosphate salt.

2. The composition of claim 1 wherein the at least two metal polycarboxylate salts are chosen from an anion group comprising citrates and oxalates.

3. The composition of claim 2 wherein the at least two metal polycarboxylate salts include zinc citrate and zinc oxalate.

4. The composition of claim 3, furthering including at least one nickel salt.

5. The composition of claim 4 wherein the at least one nickel salt is selected from the group comprising: nickel oxalate and nickel phosphate.

6. The composition of claim 3 wherein the at least one non-lithium metallic phosphate salt is selected from the group comprising nickel phosphate and magnesium phosphate.

7. The composition of claim 5 wherein the nickel salt is nickel oxalate and the composition further includes a fourth salt selected from the group comprising: a nickel phosphate or a magnesium phosphate.

8. The composition of claim 6 wherein the non-lithium phosphate salt is magnesium phosphate.

9. A corrosion protection coating for a metallic surface, the corrosion protection coating comprising the corrosion inhibitor composition of claim 1 and a binder.

10. The corrosion protection coating of claim 9 wherein the binder is film-forming binder.

11. The corrosion protection coating of claim 9 in the form of: a paint, a primer, a grease, an oil, a gel, a wax, an elastomer, a sealant, and or a gasket.

12. The corrosion protection coating of claim 9, further comprising coated or uncoated metal particles.

13. The corrosion protection coating of claim 12 wherein the metal particles are coated and the coating is a semi-conducting corrosion inhibiting coating.

14. The corrosion protection coating of claim 13 wherein the semi-conducting corrosion inhibiting coating is a nanometer scale semi-conducting corrosion inhibiting oxide, the oxide derived from an acidic aqueous solution consisting essentially of, in parts by weight,
from 0.01 to 22 parts of a trivalent chromium compound,
from 0.01 to 12 parts of a hexafluorozirconate, and
from 0.01 to 12 parts of at least one fluorocompound selected from the group consisting of tetrafluoroborates, hexafluorosilicates, and hexafluorotitanates.

15. The corrosion protection coating of any of claim 9, wherein the metallic surface, includes an aluminum alloy surface.

16. A corrosion protection coating for a metallic surface, comprising:
a binder; and
a corrosion inhibitor mix comprising zinc oxalate, zinc citrate, and magnesium phosphate.

17. The corrosion protection coating of claim 16 further including metal particles.

18. The corrosion protection coating of claim 17 wherein the metal particles are aluminum alloy and coated with a semiconductive coating.

19. The corrosion protection coating of claim 18 wherein the binder comprises a resin selected from one or more of the following: epoxy resins, polyesters, polyacrylates, polyurethanes, polyethers, polyaspartic esters, polysiloxanes, isocyanates, mercapto-functional resins, amine-functional resins, amide-functional resins, imide-functional resin, silane-containing resins, polysiloxanes, acetoacetate resins, functional fluorinated resins, alkyd resins, and mixtures thereof.

20. The corrosion protection coating of claim 19 wherein the corrosion inhibitor mix consists essentially of zinc oxalate 25-75% by weight of inhibitor mix, zinc citrate 25-75%, and magnesium phosphate 5-30%.

21. A method of protecting an aluminum alloy comprising at least part of a surface of an aircraft, the method comprising:
coating the surface with a corrosion protection coating comprising a binder, a corrosion inhibitor mix, and coated aluminum alloy particles that are more anodic than the aluminum alloy surface;
wherein the corrosion inhibitor mix consists essentially of zinc oxalate 25-75% by weight of inhibitor mix, zinc citrate 25-75%, and magnesium phosphate 5-30%.

22. A method of making a corrosion inhibiting product, the method comprising:
mixing a corrosion inhibitor mix with a binder, the corrosion inhibitor mix comprising zinc oxalate 25-75% by weight of inhibitor mix, zinc citrate 25-75%, and magnesium phosphate 5-30%;
wherein the binder is selected to form a paint, a primer, a grease, an oil, a gel, a wax, an elastomer, a sealant or a gasket.

23. A corrosion protection coating for a metallic surface, comprising:
a binder; and
a corrosion inhibitor mix comprising zinc oxalate, zinc citrate, nickel oxalate and nickel phosphate.

24. The corrosion protection coating of claim 23 further including metal particles.

25. The corrosion protection coating of claim 24 wherein the metal particles are aluminum alloy and coated with a semiconductive coating.

26. The corrosion protection coating of claim 25 wherein the binder comprises a resin selected from one or more of the following: epoxy resins, polyesters, polyacrylates, polyurethanes, polyethers, polyaspartic esters, polysiloxanes, isocyanates, mercapto-functional resins, amine-functional resins, amide-functional resins, imide-functional resin, silane-containing resins, polysiloxanes, acetoacetate resins, functional fluorinated resins, alkyd resins, and mixtures thereof.

27. The corrosion protection coating of claim 26 wherein the corrosion inhibitor mix consists essentially of Zinc Oxalate 25-75% by weight, Zinc Citrate 25-75%, Nickel Oxalate 5-30% and Nickel Phosphate 5-30%.

28. A method of protecting an aluminum alloy comprising at least part of a surface of an aircraft, the method comprising:
coating the surface with a corrosion protection coating comprising a binder, a corrosion inhibitor mix, and coated aluminum alloy particles that are more anodic than the aluminum alloy surface;
wherein the corrosion inhibitor mix consists essentially of zinc oxalate 25-75% by weight of inhibitor mix, zinc citrate 25-75%, nickel oxalate 5-30% and nickel phosphate 5-30%.

29. A method of making a corrosion inhibiting product, the method comprising:
mixing a corrosion inhibitor mix with a binder, the corrosion inhibitor mix comprising zinc oxalate 25-75% by weight of inhibitor mix, zinc citrate 25-75%, and nickel oxalate 5-30% and nickel phosphate 5-30% wherein the binder is selected to form a paint, a primer, a grease, an oil, a gel, a wax, an elastomer, a sealant or a gasket.
